(19) United States
(12) Patent Application Publication
(10) Pub. No.: US 2008/0172915 A1
(43) Pub. Date: Jul. 24, 2008

(54) Multi-Function Promotional Display System

(75) Inventors: David Christopher Howe, Derry, NH (US); Gary Lee Bickford, Rochester, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: BrandPartners, Rochester, NH (US)

(21) Appl. No.: 11/972,223

(22) Filed: Jan. 10, 2008

Related U.S. Application Data
(60) Provisional application No. 60/884,260, filed on Jan. 10, 2007.

(51) Int. Cl. G09F 9/33

(52) U.S. Cl. 40/463; 40/508

(57) ABSTRACT

A multifunction display system includes a base coupled to an upright support and at least one display element. The upright support includes multiple display item fastening mechanisms including a graphic gripper regions, one or more captured element engagement regions and one or more threaded holes on the side of the upright to which may be attached various types of promotional display elements. Various items such as posters, hooks, rods, shelves and the like may be attached to the upright support anywhere along its length as desired by the user.

### RELATED APPLICATION

This application is related to and claims priority from U.S. provisional Application No. 60/884,260 filed Jan. 10, 2007 entitled Multi-Function Promotional Display which is incorporated fully herein by reference.

### TECHNICAL FIELD

The present invention relates to promotional display stands or kiosks and more particularly, relates to a multi-function, reconfigurable promotional display system that incorporates a display element holding support, support base, and multiple display mechanisms within one device.

### BACKGROUND INFORMATION

Retail establishments such as stores as well as service providers such as banks and insurance companies now make extensive use of display stands in their respective businesses to advertise and promote their products and services. These display stands, however, have traditionally been designed specifically for one particular type of insert and size. Further more they lack dimensionality and the ability to be reconfigured or retasked. In order to increase impact, dimensionality and interest in a display, a store's alternative is to use a disposable display. With this approach, the entire display is thrown out after it is no longer needed. The display thus lacks a permanent, upscale presence or image. Another alternative would be to purchase several kinds of displays for banners, paper inserts, cut out graphics etc. . . . which is prohibitive due to cost, implementation and storage limitations.

Accordingly, what is needed is a multifunction promotional display system including a support stand that can be utilized to hold many different types of advertising display elements or items in many different ways; which is self-supporting; adds dimension; can be wall mounted or free standing; is flexible and modular to gang and various sized displays; can be reused; can be attached through the ceiling; can accommodate power and data wiring; has self storing components; can be retasked, and has the ability to mechanically fasten multiple hardware attachments for supporting additional display pieces, digital screens, digital drivers and the like.

### SUMMARY OF THE INVENTION

The present invention is directed to a multi-function display system comprising a support base and an upright support member having a first end, a second end. In one embodiment, the upright support includes first through fourth sides while in another, the upright support includes at least three sides. The upright support is supportably coupled to support base proximate its first end. The upright support includes first and second display element engagement regions disposed on the first and second sides respectively of the upright support, and extending from an exterior surface of the first and second sides to an interior region of the upright support. Each of the first and second display element engagement regions include a plurality of display element support capture element types, each capture element type configured for supporting, independently of the other capture element types, a display element. Each capture element type extends generally an entire length of the upright support from the first end to the second end,

The upright support further includes third and fourth display element engagement regions disposed on the third and fourth sides respectively of the upright support. Each of the third and fourth display element engagement regions include a plurality of display element capture elements. The plurality of display element capture elements are disposed periodically along the length of the upright support from the first end to the second end and extending from an exterior surface of the third and fourth sides to an interior region of the upright support.

In one embodiment, the upright support is an extruded length of material selected from the group consisting of aluminum, steel, plastic and composite material. Further, the third and fourth sides may be provided as magnetically attractable.

In the preferred embodiment, the first and second sides of the upright support are disposed opposite one another while the third and fourth sides of the upright support are disposed opposite one another. The upright support further includes, in the interior region, first and second channels disposed proximate the third and fourth sides, and the configured for facilitating supportably connecting the support base to the upright support.

The display element support capture elements of the first and second display element engagement regions are selected from the group consisting of a gripper engagement region, a mechanical fastener “T” nut engagement region, and/or other type(s) of mechanical fasteners engagement region.

It is important to note that the present invention is not intended to be limited to a device or method which must satisfy one or more of any stated or implied objects or features of the invention. It is also important to note that the present invention is not limited to the preferred, exemplary, or primary embodiment(s) described herein.

### BRIEF DESCRIPTION OF THE DRAWINGS

These and other features and advantages of the present invention will be better understood by reading the following detailed description, taken together with the drawings wherein:

FIG. 1 is a front view of a multifunction promotional support stand or kiosks in accordance with the teachings of the present invention;

FIG. 2 is a detailed cross-sectional view of the preferred embodiment of the upright support of the present invention;

FIG. 3 is a schematic diagram showing a shelf feature and configuration of the multifunction display stand of the present invention;

FIG. 4 is a schematic diagram showing a banner feature inserted into the gripper region of the upright support which forms part of the multifunction display stand of the present invention;

FIGS. 5A-5D are plan views showing a several illustrations of how the multifunction support stand of the present invention may be utilized for advertising or promotional displays;

FIGS. 6A-6B illustrate several other uses of the multifunction display stand of the present invention in which two or more upright supports are utilized to support a larger wall type structure to serve as a large display element or perhaps a self standing visual screen or barrier; and

FIGS. 7A and 7B illustrate the multifunction support stand of the present invention extending from floor to ceiling or freestanding and shown supporting an electronic display element such as an LCD display.

### DETAILED DESCRIPTION OF THE PREFERRED EMBODIMENTS

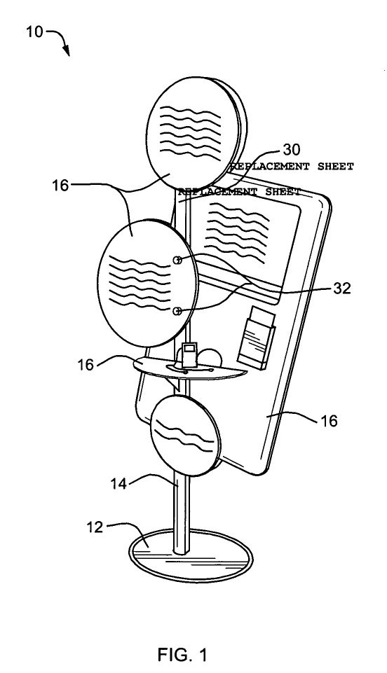

The present invention features a novel, multifunction promotional stand or kiosk system 10, FIG. 1 that is adapted to hold many different types of display elements including, but not limited to, words, images, flags, banners, digital electronic displays, hooks for holding items, shelves for product display, gift or giveaway items, white boards and the like.

One feature of the present invention is a multi-function, standardized promotional stand fixture including a base 12 and an extruded multifunction upright support 14. The base 12 may be formed of plastic, metal, a combination thereof, or any other suitable material which can be attached to the upright 14 and which is both strong enough and large enough to support and balance the weight of the upright support 14 as well as any and all graphic display elements or items 16 attached to the upright support 14.

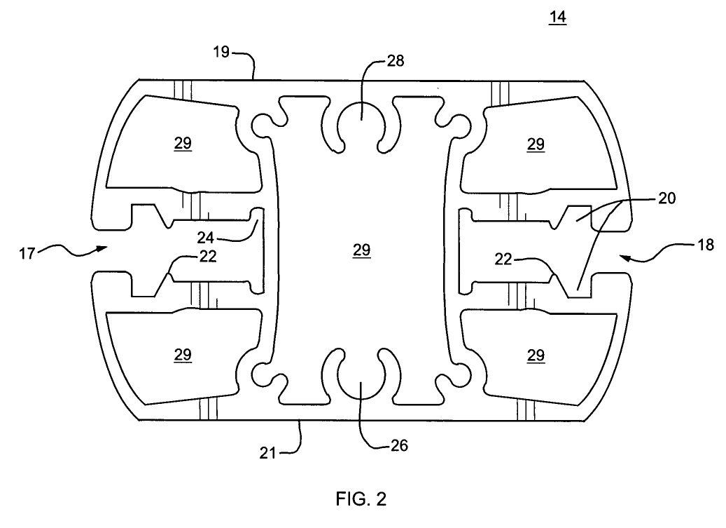

As shown in greater detail in FIG. 2, upright support 14 is a generally four-sided extruded aluminum structure including first and second display item engagement regions 17 and 18. As contemplated by the preferred embodiment, the first and second display item engagement regions are identical although this is not a limitation of the present invention. Making the engagement regions identical, however, aids in facilitating a truly standardized, multifunction display device.

The first and second engagement regions 17, 18 each include a first region 20 into which may be inserted a T-nut or other similar capture device to support a banner or rod, hook, shelf or the like. Such capture devices can be inserted either from the side through a T-nut type fastener or from the top of the support 14 and slid down and are tightened at the appropriate height desired.

The first and second engagement regions 17, 18 each also include a graphic gripper region 22 consisting of two protrusions into the engagement regions 17 and 18. The two protrusions serve to engage with and “grip” a sintra, foam core, gater foam, cardboard or other similar generally rigid graphic that slides into the engagement regions 17 or 18 and engages with the protrusions 22. By simply pulling on the graphic, the graphic can be removed from engagement with the protrusions 22.

The support 14 further includes a third engagement region 24 into which another type of capture device having a head that fits into the region 24 may be inserted to hold a capture device and an advertising display element in place against the upright support 14.

Upright support 14 also includes third and fourth display item engagement regions 19 and 21 which preferably are generally flat, planar surfaces having periodically placed threaded holes (not shown) in the generally planar sides 19, 21 of the upright support 14. The threaded holes are used to fasten and support one or more display elements as shown in FIG. 1 using a threaded bolt which goes through the display element 16 and into the threaded hole. These regions can also be used to support additional hardware devices. The threaded holes are typically spaced apart on the side of the support 14 from the bottom to the top of the support at preset intervals. The ability to vertically support display elements 16 adds another three-dimensional layer of graphic imagery to an advertising display.

Alternatively or in addition, the generally flat, planar surfaces 19 and 21 of the upright support 14 are ideal for interconnecting with a graphic image holder of the type disclosed in the co-pending U.S. patent application Ser. No. 11/621,680 entitled “Graphic Image Holder” owned by the assignee of the present invention and incorporated fully herein by reference.

Channels 26 and 28 are provided on the support 14 to interconnect the upright support 14 with the base 12. Channels 26 and 28 may be threaded or not threaded as one with skill in the art can appreciate. In addition, open areas 29 provide a convenient area in which electrical wires may be run within the support member in the case of electronically operated display elements. In addition, the open areas 29 may also provide storage for display elements or portions of display elements.

The upright support 14 is preferably dimensioned at approximately 3¼ inches wide by 2 inches deep although this is for exemplary purposes only and is not a limitation of the present invention. The uprights of Port 14 may be made of aluminum, steel, plastic, composite materials or any combination thereof or other suitable material that will serve the intended purpose.

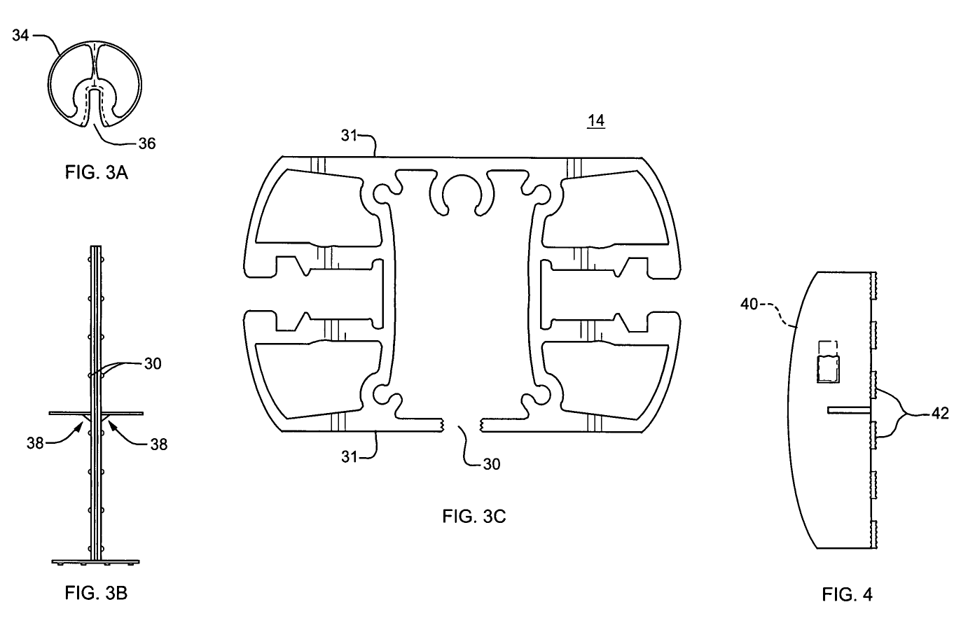

Various display elements 16 may be supported as previously mentioned including shelves such as shelf 34, FIG. 3 which includes an opening 36 to fit around the upright support 14. The shelf 34 also includes several angle brackets 38 which serve to help support and stabilize the shelf and hold the shelf in place using one or more nuts or bolts 32 inserted into the threaded regions found in the sides 19, 21 of the upright support. The shelf 34 may be made out of plastic or aluminum or other similar suitable material and may also be coated with a nonslip material such as neoprene rubber or the like so that items placed on the shelf do not tend to slide off.

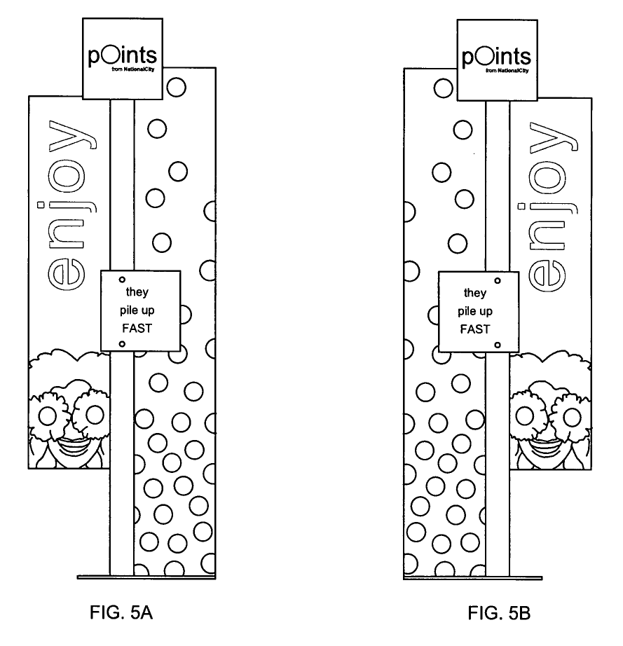

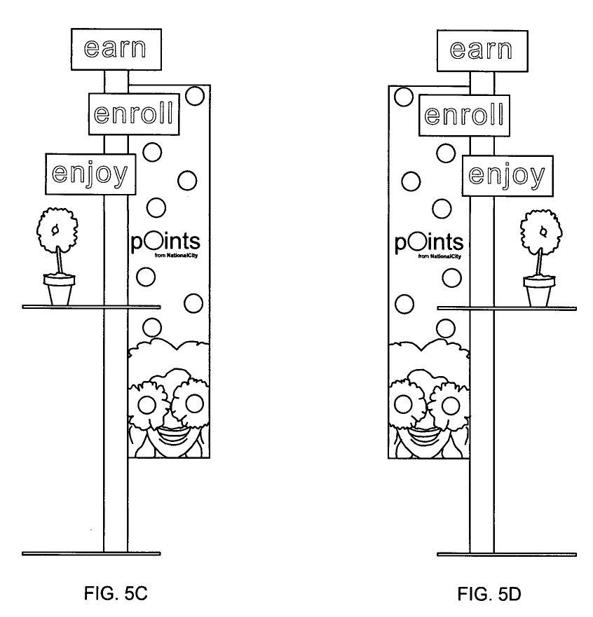

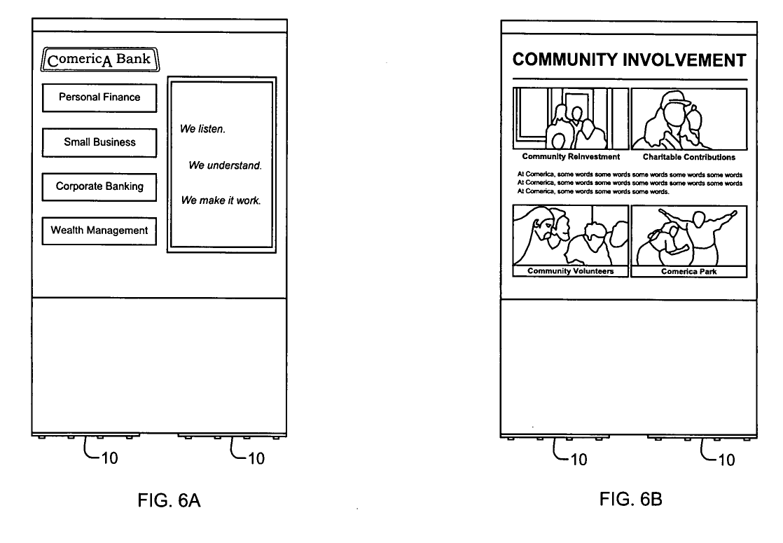

Upright display element 40, FIG. 4 may include one or more regions 42 which engage with the gripper region 22 of the upright support 14. As shown in FIGS. 5A-5D, the present invention may be utilized to create multisided, multi-dimensional graphical displays which are self standing and which can easily and quickly be moved, changed and rearranged. In addition, several of the multifunction promotional stands 10, FIGS. 6A and 6B in accordance with the present invention, may be utilized together to create a larger display or “wall” or divider for displaying large images or information or for serving as a site screen or barrier.

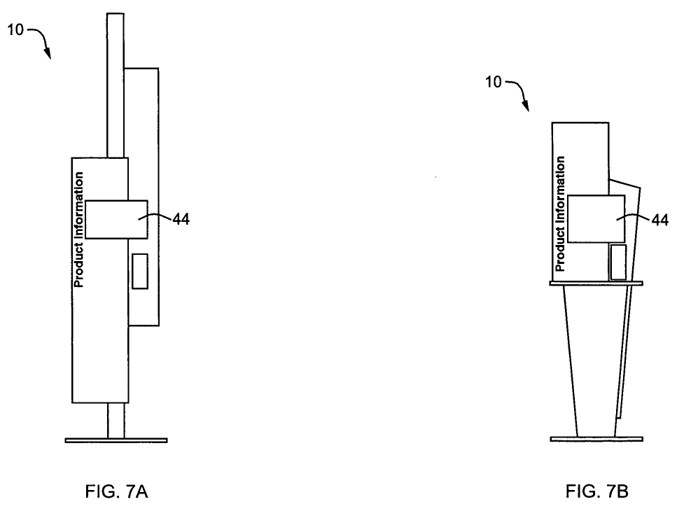

As shown in FIG. 7A, the multifunction promotional stand of the present invention may extend from floor to ceiling or may be freestanding, 7B. Additional examples of display elements which may be attached to the multifunction promotional stand include LCD displays 44.

Accordingly, the present invention provides a multifunction promotional stand which is convenient that is, easy to set up and be configured or reconfigured; is compact meaning it does not take up much floor space and parts may be easily stored within the support structure or shelves nested on the base when not in use thus minimizing damage and loss of pieces; is flexible in that it accommodates a wide variety of display devices of varying sizes and types; is dynamic in that the user can have nearly an endless possibility of configurations of graphics to highlight their promotion; and is impactfull in that it allows the user to make use of uniquely shaped and sized graphics to create multidimensional displays to attract the attention of a purchaser in any retail or other environment.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

What is claimed is:

1. A multi-function display system, comprising:
a support base;
at least one display element; and
an upright support member having a first end, a second end, and first through fourth sides, said upright support supportably coupled to said support base proximate said first end, said upright support including first and second display element engagement regions disposed on said first and second sides respectively of said upright support and extending from an exterior surface of said first and second sides to an interior region of said upright support, each of said first and second display element engagement regions including a plurality of display element support capture element types, each capture element type configured for supporting, independently of said other capture element types, a display element, each capture element type extending generally an entire length of said upright support from said first end to said second end, said upright support further including third and fourth display element engagement regions disposed on said third and fourth sides respectively of said upright support, each of said third and fourth display element engagement regions including a plurality of display element capture elements, said plurality of display element capture elements disposed periodically along said length of said upright support from said first end to said second end and extending from an exterior surface of said third and fourth sides to an interior region of said upright support.

2. The display system of claim 1, wherein said upright support is an extruded length of material.

3. The display system of claim 2, wherein said material is selected from the group consisting of aluminum, steel, plastic and composite material.

4. The display system of claim 1, wherein said third and fourth sides are magnetically attractable.

5. The display system of claim 1, wherein said first and second sides of said upright support are disposed opposite one another and wherein said third and fourth sides of said upright support are disposed opposite one another.

6. The display system of claim 1, wherein said upright support further includes, in said interior region, first and second channels disposed proximate said third and fourth sides, said first and second channels configured for facilitating supportably connecting said support base to said upright support.

7. The display system of claim 1, wherein said display element support capture elements of said first and second display element engagement regions are selected from the group consisting of a gripper engagement region, a “T” nut engagement region, and a mechanical fastener engagement region.

8. The display system of claim 1, wherein said at least one display element is selected from the group consisting of a shelf, a two dimensional display grid and an electronic display device.

9. A multi-function display system, comprising:
a support base;
at least one display element; and
an upright support member having a first end, a second end, and a plurality of sides, said upright support supportably coupled to said support base proximate said first end, said upright support including at least first and second display element engagement regions disposed on first and second sides respectively of said upright support, and extending from an exterior surface of said first and second sides to an interior region of said upright support, each of said first and second display element engagement regions including a plurality of display element support capture element types, each capture element type configured for supporting, independently of said other capture element types, a display element, each capture element type extending generally an entire length of said upright support from said first end to said second end, said upright support further including at least a third display element engagement region disposed on at least a third side respectively of said upright support, said third display element engagement region including a plurality of display element capture elements, said plurality of display element capture elements disposed periodically along said length of said upright support from said first end to said second end and extending from an exterior surface of said at least a third side to an interior region of said upright support.

10. The multifunction display system of claim 9, wherein said upright support is the three sided support.

11. The multifunction display system of claim 10, wherein said first through third sides of said support each include a display element engagement region extending from an exterior surface of said first through third sides to an interior region of said upright support, each of said display element engagement regions including a plurality of display element support capture element types, each capture element type configured for supporting, independently of said other capture element types, a display element, each capture element type extending generally an entire length of said upright support from said first end to said second end.

12. The display system of claim 9, wherein said at least one display element is selected from the group consisting of a shelf, a two dimensional display grid and an electronic display device.
